(19) United States
(12) Patent Application Publication
(10) Pub. No.: US 2005/0170311 A1
(43) Pub. Date: Aug. 4, 2005

(54) Method and device for placing dental implants

(76) Inventors: Philippe Tardieu, La Tronche (FR); Luc Vrielinck, Genk (BE)

Correspondence Address: CLARK & ELBING LLP, 101 FEDERAL STREET, BOSTON, MA, 02110, US

(21) Appl. No.: 10/505,846

(22) PCT Filed: Feb. 28, 2003
(86) PCT No.: PCT/FR03/00667

(30) Foreign Application Priority Data
Feb. 28, 2002 (FR) 02/02587

(51) Int. Cl. A61C 3/02; A61C 8/00

(52) U.S. Cl. 433/76; 433/173

(57) ABSTRACT

The invention relates to a method and device for placing implants (1) using a surgical template (11) which is made from tomographic cuts in the patient's jawbone (7). According to the invention, step drills (4) and calibrating drills (5), having a single standard diameter for each type of implant (1), are guided through drill bushings (18) which are inserted into bores (15) in the template (11) in order to produce any drilling sequence corresponding to an implant plan. The penetration depth of the drills (4, 5) is controlled by the height of the bores (15) or by the drill rings (21). The aforementioned template (11) bores (15) serve as a guide for the precise placement of the implants (1) owing to the adapted implant supports (3). Moreover, washers (23), which are mounted around the implant supports (3), limit compression in relation to the implants (1) while said implants are being placed (20). The above-mentioned characteristics serve to limit the required number of drills (4, 5) and implant supports (3) to the longest models only. The inventive method and device are particularly suitable for computer-assisted implantology systems.

### TECHNICAL FIELD OF THE INVENTION

The present invention relates to a method and a device for placing dental implants.

### BACKGROUND OF THE INVENTION

Esthetical considerations or therapeutic indications often lead to the replacement of missing teeth of a highly deteriorated denture of a patient by an implant. The most common prostheses are still the tooth or tissue borne prosthesis, while the placement of prostheses anchored in the mandible or the maxilla of the patient by way of one or more implants screwed into holes drilled in the boney tissue is being developed.

Modern medical imaging techniques coupled to robotics make it possible to simulate on computer the placement of implants in three dimensions before any intervention is done, and to produce a drilling template that will guide the surgeon-dentist during the operation. The use of these techniques has considerably increased the rate of aesthetic success, while decreasing the risk of post-operative complications.

Such a method and a device for determining the ideal placement of an implant and conceived for the exact placement thereof are described in U.S. Pat. No. 5,320,529, in the name of D. Pompa, published Jun. 14, 1994.

A stereolithographic model of the jawbone is made starting from tomographic sections, allowing the practitioner to simulate on this model the placement of the prostheses. A surgical template is obtained by moulding of the bone model and radio-opaque models of the implants in place, armed with their fixture mounts. Drilling tubes with an inside diameter which corresponds to drills of different sizes are thereafter placed on the imprint of the fixture mounts.

This method makes it possible to obtain a precise surgical template, but does not completely make use of the possibilities and the advantages of a computer simulation, as this template is obtained by recreating the implant simulation by moulding staring from a real bone model and not from a viral model.

The drilling template described in international patent application WO 99/26540, in the name of M. Klein et al., published on Jun. 3, 1999, is based on the previously described principle of using drilling tubes of different diameters inserted into bore tubes of a single diameter, except for the fact that they are inserted into cylinders which are themselves placed in bore tubes drilled directly into the scannographic guide by a drilling machine under numerical control based on scanning data.

The need for an additional moulding step is thus removed by proceeding in this manner.

Nevertheless, the method and device described in application WO 99/26540 seem to be applicable only to tooth borne templates, and not to bone or tissue borne templates. Moreover, the drilling tubes are maintained in place in the cylinders by a flange and a clamping screw, which represents a major inconvenience. Besides the handling difficulties linked both to the placement and to the control of such a high number of elements in a patient's mouth, and to the instability of their fixation, the system of drilling tubes of varying diameter held by screws also compromises the safety of the intervention as it remains possible that one of the pieces is ingested.

The drawings illustrating the publication (Practical Procedures & Aesthetic Dentistery, Vol. 13, No. 2, March 2001, pages 165-9, M. Klein et al.) of the results obtained by the method and the device subject of application WO 99/26540 clearly illustrate the excessive bulkiness of the flange of the cylinder, and the difficulty to access the screw without grips with a hexagon socket in radial position.

The method for producing models of parts of the human body based on digital images revealed by the company Materialise in Belgian patent BE-1.008. 372, published on Apr. 2, 1996, and applied specifically to computer assisted implantology, provides an additional simplification by allowing the production by stereolithography, a rapid prototyping technique well known in plastification, of models of mandibles, maxillas and surgical templates corresponding to any required implant planning.

The software derived from this patented method for the acquisition of scanner data, the computer simulation of the mandible or maxilla, the visualisation of the design of the implants and the template, as well as the guiding of the prototyping machine, is commercialised under the name of SurgiCase® and offers the practitioner a solution which is widely applicable.

Starting from the scanner data, the implantologist using the software prepares a virtual implant planning and transmits the results to the service center charged with converting these data into actual drilling templates. During the operation, a template is positioned on the alveolar crest; due to the complexity of the forms of the jaws and the teeth, the position of the template is unique and stable. The templates contain cylinders in sinless steel that can be implanted, which make up the physical guides for the drills during surgery and allow to control the drilling axis in an optimal way. Several templates are made with cylinders of different diameters making it possible to take into account the specific drilling sequence for every implant, and to adapt appropriately to every individual case. When the site is ready, the implants are inserted in a usual way using fixture mounts.

Nevertheless, the need to use a plurality of templates somewhat reduces the advantages of the simplification obtained by making use of the method of the company Materialise.

It is thus clear from the documents cited above that different methods and devices for the placement of dental implants are known in the state of the art; nevertheless, these methods and devices do not entirely meet the needs of the practitioner, who is still limited by too many constraints in their use.

### GENERAL DESCRIPTION OF THE INVENTION

The present invention relates to a method and a device for the placement of dental implants which aims to eliminate the constraints related to the use of the methods and systems of the prior art.

More specifically the object of the invention is a method of the type comprising following steps:
a) placement in the mouth of the patient of a scannographic guide,
b) acquisition by the computer of the scanner data of the guide, as well as of the mandible or the maxilla of the patient,
c) simulation on the computer of the mandible or the maxilla starting from the scanner data,
d) generation by the computer, under control of the practitioner, of implant planning parameters based on this simulation,
e) control by computer based on the planning parameters of a device for the production of a template featuring bore tubes with predetermined inclinations and positions,
f) securing in these bore tubes guiding cylinders of one single standard dimension predetermined in function of the type of implants,
g) insertion into the guiding cylinders of tubes arranged so as to control the direction and the depth of insertion of drills,
h) drilling, by means of drills that are used successively and through the drilling tubes, of holes in the mandible or maxilla which are intended to receive the implants, and
i) placement of implants through the guiding cylinders in the holes by way of fixture mounts.

The method for the placement of dental implants according to the invention consists in:
pre-producing the drilling tubes having one single predetermined standard inside diameter in function of the type of implants,
pre-producing a first set of drills consisting of staged drills of which the maximal standard diameter corresponds to the inside diameter of the drilling tubes,
pre-producing a second set of drills consisting of calibration drills of which the nominal standard diameter corresponds to the inside diameter of the tubes,
   so as to ensure the drilling procedure specific for each implant while only using for each hole first one of the staged drills, and then one of the calibration drills, instead of having to subsequently use a plurality of drills and tubes of increasing diameters.

The method of the invention is also of interest because the placement of the implants is guided by specific fixture mounts that glide into the cylinders of the template.

The method for the placement of dental implants of the invention is also remarkable because of the fact that the implantation planning parameters contain the heights of the bore tubes calculated by computer or determined by the practitioner, so as to control without additional means the depth of penetration of the bores in the maxilla or mandible of the patient.

Alternatively or simultaneously, according to a variation of the method for the placement of dental implants according to the invention, a set of rings with an inside diameter corresponding to the diameter of the bores is pre-produced. A first intermediate step of the method then consists of placing, or not, depending on the need thereof at least one of the rings on the bores so as to control the depth of penetration into the mandible or maxilla of the patient.

The drilling operation draws an advantage of these two last particular characteristics of the method when only staged drills and calibration drills of one standard length predetermined in function of the type of implants are used, independent of the depth of the osteotomies to be obtained.

The method according to the invention also has the advantage that a set of washers with inside diameters corresponding to the diameter of the fixture mounts can be pre-produced. When necessary, during a second intermediate stage, the placement of one or more of these washers on the fixture mounts allows to control the depth of penetration of the implants.

In this latter case, the implant procedure is preferably performed with fixture mounts of one single standard length in function of the type of implants, independent of the height of the implants to be placed.

One additional characteristic of the method is that the insertion of the tubes in the guiding cylinders is preferably achieved by screwing. Moreover, the fixation of the cylinders in the template is preferably done by pasting.

The method for the placement of dental implants according to the invention is preferably performed by a device of the type comprising:
a) a scannographic guide for being placed in the mouth of the patient,
b) a first computer implemented acquisition system of the scanning data of the guide and of the mandible or maxilla of this patient,
c) a second computerised data simulation system of the mandible or the maxilla based on the scanning data,
d) a third computerised system for the generation of dental planning parameters based on this simulation,
e) a fourth system for drilling template formation which can be computer controlled,
f) a fifth system for computer control of this fourth system based on the planning parameters,
g) bore tubes in the template at predetermined angles and positions, and armed with guiding cylinders of predetermined standard size in function of the type of implants,
h) drilling bores coaxially placed in the upper part of the guiding cylinders,
i) drills of which the diameters correspond to the inside diameter of the tubes, and
j) fixture mounts.

An essential characteristic of the device according to the present invention is that the drilling tubes all have one standard inside diameter predetermined in function of the type of implants and that the drills present a first set of staged drills and an second set of calibration drills of which, respectively, the maximal standard diameter and the nominal standard diameter correspond to the inside diameter of these tubes.

Advantageously, each of these staged drills comprises, successively along its axis, staring from the pointed end to the other end:
a first length of the drill having a section with a single standard diameter, pre-determined in function of the type of implants,
a second length of the drill, adjacent to the first length, with a single standard diameter pre-determined in function of the type of said implants and larger than the diameter of the first drill section,
a smooth part with a single standard diameter predetermined in function of the type of the implants and corresponding to the inside diameter of the drilling tubes,
a flange, and
a standard blocking means for a handpiece.

In a similar advantageous way, each of the calibration drills preferably present successively along its axis, starting from the pointed end to the other end:
a first cutting section with a single standard diameter, pre-determined in function of the type of implants and corresponding to the standard inside diameter of the drilling tubes,
a second cutting section with a diameter significantly smaller than the diameter of the first cutting section,
a smooth zone with a single diameter predetermined in function of the type of implants and corresponding to the unique inside diameter of the drilling tubes,
a flange,
a standard blocking means for a handpiece.

The fixture mounts of the present invention are further advantageous when they each comprise, on the one hand, a mandrel which features, successively along its axis:
a piece complementary to a handpiece-connector,
a flange,
a smooth section of a single standard external diameter predetermined in function of the type of implants and corresponding to the standard inside diameter of the guiding cylinders, and
a piece complementary to the standard heads of the implants,
   and, on the other hand, a screw which passes through the mandrel and is screwed in the head of the implant.

An additional feature of the device for the placement of dental implants according to the invention is that the bore tubes of the template have a variable height in order to limit, without any additional means, the insertion depth of the drills in the mandible or the maxilla of the patient during the operation.

Alternatively or simultaneously, the device for the placement of dental implants according to the invention additionally comprises a set of rings with inside diameters corresponding to the diameter of the drills, said rings intended to be slid over the smooth drill section or smooth drill zone of each drill in order to control the penetration depth.

In these latter two embodiments, the staged drills and the calibration drills of the device for the placement of dental implants according to the invention are all of a predetermined standard length pre-determined in function of the type of implants, independent of the depth of the holes to be made, thus representing “universal” drills.

Advantageously, the device for the placement of dental implants according to the invention further comprises a set of washers with an inside diameter corresponding to the diameter of the fixture mounts, the washers intended to be slid over the smooth sections of each of the fixture mounts in order to control the depth of penetration of the implant.

Fixture mounts of one single predetermined standard length in function of the type of implants, and thus functioning as “universal” fixture mounts, have advantage of this latter feature.

Preferably, the cylinders and the drilling tubes of the device according to the invention respectively have an internal screw thread and an external screw thread featuring four helixes at a 90° angle with respect to each other.

Most advantageously, each of the tubes of this device features a ring with a tangential slot.

Alternatively or simultaneously, this ring contains four blind radial holes at 90° with respect to each other.

According to an additional feature of the device for the placement of dental implants which is the subject of the present application, the rings and the washers which are intended for placement around the drills or the future mounts respectively, are made of a bio-compatible plastic material, preferably of polyoxymethacrylate (POM).

As for the guiding cylinders in the template, these are preferably made of a titanium alloy, most preferably of TA6V, just as the mandrels of the future mounts, while the tubes are in steel, preferably in stainless steel INOX 316L.

These few essential characteristics will make it clear to the skilled person what the advantages are of the method and device for the placement of dental implants according to the invention compared to those of the prior art.

The detailed characteristics of the invention, and more specifically the examples illustrating advantageous selections of dimensional characteristics of the device are provided in the following description, accompanied by the enclosed figures. It is to be noted that these figures are but an illustration of the text of the description and should not be considered in any way to present a limitation to the scope of the invention.

### BRIEF DESCRIPTION OF THE DRAWINGS

FIG. 1 represents an overview of the different steps which make up the methods for the placement of dental implants known in the state of the art to which the present invention relates.

FIG. 2 is an exploded view of part of the device according to the invention during the drilling step, featuring more particularly the drilling template, the guides and a staged drill and its ring.

FIGS. 3a and 3b are respectively a sectional view (along A-A) and a top view of a guiding cylinder of the template.

FIGS. 4a and 4b are respectively a front view and a top view of a drilling tube of the template

FIGS. 5a and 5b are respectively a sectional view (along B-B) and a top view of a drilling ring used to limit the depth of penetration.

FIGS. 6 and 7 are respectively a front view of a staged drill and a calibration drill.

FIG. 8 is an exploded view of part of the device according to the invention during the step of placement of the implants, featuring more particularly the drilling template, an implant, a washer, a fixture mount and its screw.

FIGS. 9a and 9b are respectively a front view and a top view of a fixture mount according to the invention.

FIG. 10 is a front view of the corresponding screw of the fixture mount.

### DESCRIPTION OF THE PREFERRED EMBODIMENTS OF THE INVENTION

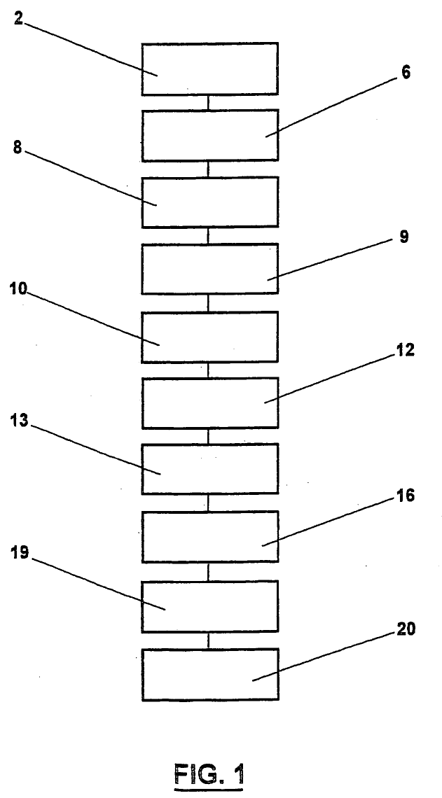

FIG. 1 is a schematic representation of the known succession of steps which lead to the placement of dental implants 1 in the mouth of a patient.

In a preliminary step 2, the practitioner having at his disposal a system of computer-assisted implantology, decides together with the patient on the placement of the implants 1. This system is a complex set of methods and devices optimised in function of the goal to be achieved. As a consequence, the characteristics of each of the elements of this system are strongly interdependent, and lead to standards of facts, which result from the generalisation of certain proprietary systems commercialised by the most important producers of medical devices. The implantologist should thus have at his disposal right from the start the material (implants 1, fixture mounts 3, drills, 4, 5, etc.) adapted to the rest of the system which he intends to use. Of course it is of interest to both the patient and the practitioner that the system used is as simple and as reliable as possible.

A scannographic guide is placed (step 6) into the mouth of the patient, after which he will undergo a scanner in the usual way. Such a scannographic guide comprises radio-opaque markers that make it possible to subsequently allow, by means of known methods, to have the reference markers of the radiologic images obtained by computer in this step 8 coincide with the points of markers of the actual prostheses.

At the end of this examination, the scanner data of the guide and the jaw 7 of the patient are sent to a service centre, which converts these raw data and prepares them before forwarding them to the implantologist.

The software which is at the disposal of the practitioner ensures a virtual reconstruction of the mandible 7 or the maxilla of his patient starting from the prepared scanner data. This computer driven simulation 9 allows to create an implant planning 10, by visualising the location of the future implants 1. The parameters of the planning 10 will be retransmitted to the service centre for the production 12 of the drilling template 11.

By a method which is known in the art, the service centre will in this production step make use of the received data to control a stereolithographic device, which has the advantage over a digital milling machine of being able to produce objects with closed cavities.

The service centre glues (step 13) the guiding cylinders 14 to the interior of the bore tubes 15 of the template 11 and sends the latter, as well as an actual model of the jaw 7 to the implantologist. The cylinders 14 are of a standard size, chosen in function of the type of implants 1 that will be placed.

During the next step 16, i.e. during the surgical procedure of the placing of the implants 1 themselves, the practitioner uses the template 11 to drill the holes 17 intended to receive the implants 1, each on the location wanted and in the right direction as determined in the planning 10.

In order to limit the heating of boney tissue 7, a hole of a small diameter is first drilled, before switching to a larger diameter in order to obtain the nominal diameter. In the classical methods, five drills are used to prepare the implantation site. Given that the guiding cylinders 14 of the template 11 are of a given diameter, several templates 11 are thus usually necessary to obtain a drilling sequence, unless use is made of a series of adaptation tubes 18 inserted into the cylinders 14.

This latter method of working is retained in the method of the present invention, but, different from the prior art, in this step 16, the drilling tubes 18 are of only one kind, the inside diameter being predetermined in function of the type of implant 1. The handling of several drilling tubes 18 for every drilling is thus eliminated: the same standard tube 18 is screwed into the cylinder 14 for the entire duration of the drilling.

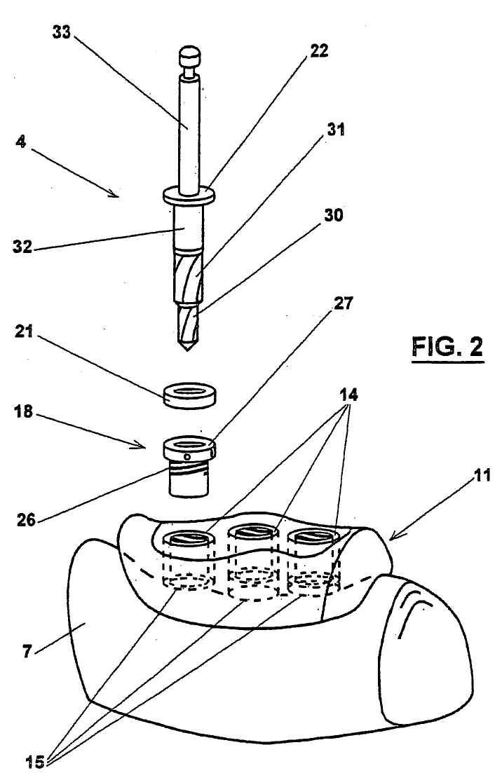

This is made possible by using, during the drilling step 19, only two drills 4,5, of a particular type: one drill named “staged drill” 4, and a second drill named “calibration drill” 5. All of these elements will be described in detail in connection with FIGS. 2, 3, 4, 6, and 7.

The method for the placement of the implant 1 is completed by introduction of the latter by way of a fixture mount 3 in the osteotomy 17 which is obtained beforehand. During this final stage 20, the implant 1 is correctly directed by a particular type of fixture mount 3, characteristic to the method of the invention, which is guided by sliding movement into the cylinder 14 of the template 11.

The drilling templates 11 used will normally feature tubes 17 of a same height predetermined at the request of the practitioner in function of the type of implants 1 that he will be using (“Standard”, “Wide”, or “Zygomatic”). Every type of implant 1 exists in different lengths. In order to drill holes 17 of corresponding depths, the drills 4, 5 thus have to be changed.

The method according to the present invention suggests to retain only the longest drills 4, 5 (“universal” drills for the type of implants 1 being considered) and to adapt their length by using the rings 21 of known thickness. These rings limit the depth of penetration of the drill 4, 5 into the bone 7 by more or less filling up the free space between the top of the template 11 placed on the osseous crest and an axial stop 22 which appears on all of the drills 4, 5.

The same principle is applied to the fixture mounts 3: washers 23 inserted around the stem 24 are used to limit the depth of the screwing of the implant 1. In this way the variability in the length of the fixture mounts 3 is limited to the only combination of the type of implants 1 and of the type “osseous” or mucous” of fixture mounts 3.

According to a variation of the method, to avoid the use of the rings 21, the practitioner specifies the heights of the bore tubes 15 of the template 11 upon production. In this method it is then the height of the stereolithographic tube 17 which is variable and not the drill 4, 5. The deeper the stereolithographic tube, all the less deep the drilling will be, while using the same guiding cylinders 14 and drilling tubes 18. This method has three advantages: first it makes use of only one length of drill 4, 5 for all depths; secondly there is no need to control the depths at each drilling, as this is predetermined by the template 11; finally, in the case of tissue borne templates 11, this allows to take into account the thickness of mucosa which is uneven in the different implantation zones, without having to perform any calculations or any adaptations.

All of the elements of a computer-assisted implantology system adapted for performing the method which has been described in detail above will not be repeated here in detail. Only those parts of the device specific to the invention will be described hereafter.

FIG. 2 clearly depicts the drilling template 11 fixed to the osseous crest of a mandible 7, with the guiding cylinders 14 in position in the bore tubes 15. This situation corresponds to the moment of step 16 when the practitioner has already screwed the drilling tubes 18 in the cylinders 14 (the tube 18 is here drawn on top of the cylinder 14 for the clarity of the representation), and is starting the operative step of drilling 19.

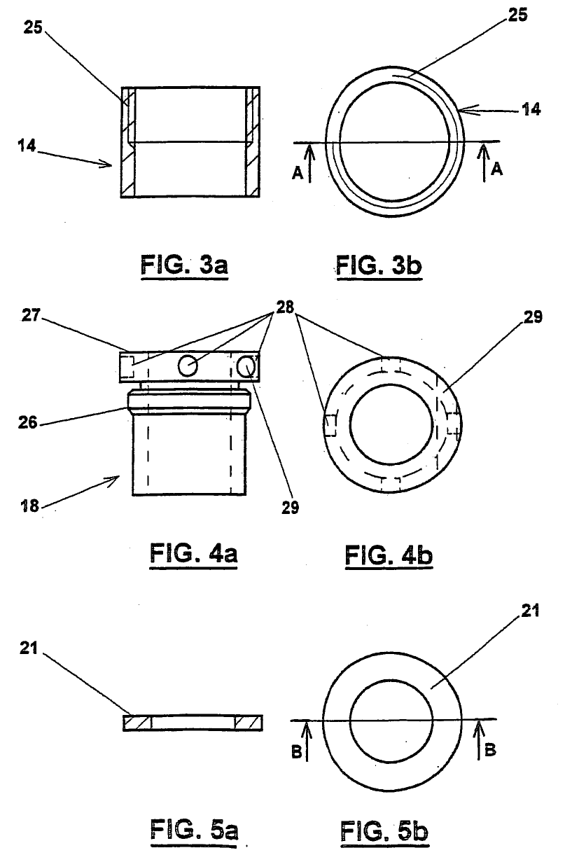

The “universal” staged drill 4 is provided with a ring 21 if the height of the bore tubes 15 is not sufficient to limit insertion thereof to a depth corresponding to the size of the implant 1. The detailed characteristics of all elements of FIG. 2 are represented in FIGS. 3 to 7.

The guiding cylinder 14 seen in section in FIG. 3a, and from above in FIG. 3b, comprises an upper threaded part 25 extending over half of its length. The screw thread presents four recessed helices spaced apart by 90°, which facilitates the screwing and unscrewing.

The cylinder 14 has a height of 4 mm. It has an inside diameter, with a dimensional tolerance H7, of 4.20 mm at the part which is not threaded. Its exterior diameter is 5.20 mm. These dimensions are suitable for implants 1 of a “standard” type, having an exterior diameter of 3.75 mm or 4.00 mm, which applies to 97% of the cases. Cylinders 14 of different sizes exist for implants of the “Wide” type with a diameter of 4.75 mm, 5 mm or 6 mm.

The cylinders 14 are made of implantable metal, preferably of the titane alloy TAV6.

The drilling tube 18, seen from the front in FIG. 4a and from above in FIG. 4b, has an external pitch 26 which is close to the top end and complementary to the threaded part 25 of cylinder 14. The four shifted relief pattern helixes allow the fixing of the tube 18 in its cylinder in a quarter of a turn only.

The handling and the fixing/releasing of the drilling tube 18 using a tool are made easier by way of a ring 27 which surrounds its upper end, and featuring four radial blind holes 28. A cylindrical tangential slot 29 allows the passing of a silk thread which serves as a parachute.

The drilling tube 18 has a height of 5 mm and apart from the screw thread, has an external diameter of 4.20 mm with a dimensional tolerance g6, thus corresponding to the inside diameter of the cylinder 14 and adjusted to fit the most common cases. The external diameter of the ring 27 is 5.2 mm and its height 0.5 mm. The inside diameter of the tube 18 is 3.20 mm for guiding drills 4, 5 with a diameter of 3.15 mm.

The drilling tubes 18 are produced in steel, preferably stainless steel INOX 316L.

The ring depicted in FIGS. 5a and 5b does not feature any particular characteristics apart from its dimensions which are adapted to the system. Its external diameter corresponds to the common diameter of the ring 27 of the drilling tube 18 and of the flange 22 of the drills 4, 5 in between which it is placed, thus being 5.2 mm. Its inside diameter of 3.10 mm is slightly smaller than the diameter of the drills 4, 5 of 3.15 mm in order for it to adhere thereto.

These rings 21 are produced in polyoxymethacrylate (POM). Rings 21 with a thickness of 0.5 mm are preferably in white coloured natural POM, while rings 21 with a thickness of 1.5 mm are preferably coloured black, so as to be more easily distinguishable from each other.

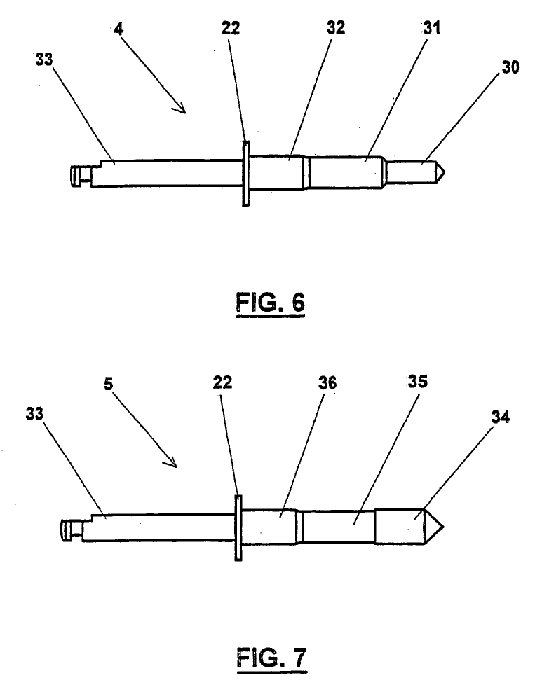

The staged drill 4 represented in FIG. 6 allows the replacement of the ball drill, the drill of 2 mm and the pilot drill by one single drill.

A staged drill 4 for an implant 1 having a length of 10 mm, but representative of the system when making use of standard implants 1, typically features:
a conical part with an opening angle of 120° followed by a first drill section 30 of 2 mm in diameter and which is 4 mm in length,
a second drill section 31 of 3 mm in diameter and 6 mm in length, including the conical connection, having an opening angle of 120° with the first drill section 30,
a smooth section 32 of 3.15 mm in diameter and 5 mm length, including the conical connector, of an opening semi-angle of 10°, with the second drill section 31,
a flange 22 of 5.2 mm in diameter and 0.5 mm thickness, and
a standard blocking means for a handpiece 33 with a total length of 14 mm.

Staged drills 4 for implant lengths of 13, 15 or 18 mm also exist but, as has been explained, the longest drill 4 of the series can be used as a “universal” drill if used with rings 21 in POM or with a template 11 featuring bore tubes 15 of variable heights.

The calibration drill 5 represented in FIG. 7 comprises an upper part 22, 33 identical to that of the staged drill 4.

In case of a standard implant 1 with a length of 10 mm, the lower part of this drill 5 typically features:
a conical part with an opening angle of 120° followed by a first drill section 34 of 3.15 mm in diameter and 4 mm in length,
a second drill section 35 of 3.00 mm in diameter and 6 mm in length,
a smooth section 36 of 3.15 mm in diameter and 5 mm in length, including the conical connection to the second drill section 35 with a semi-angle opening of 10°.

The staged drills 4 as well as the calibration drills 5 are made of stainless steel, preferably of the type Z33C13.

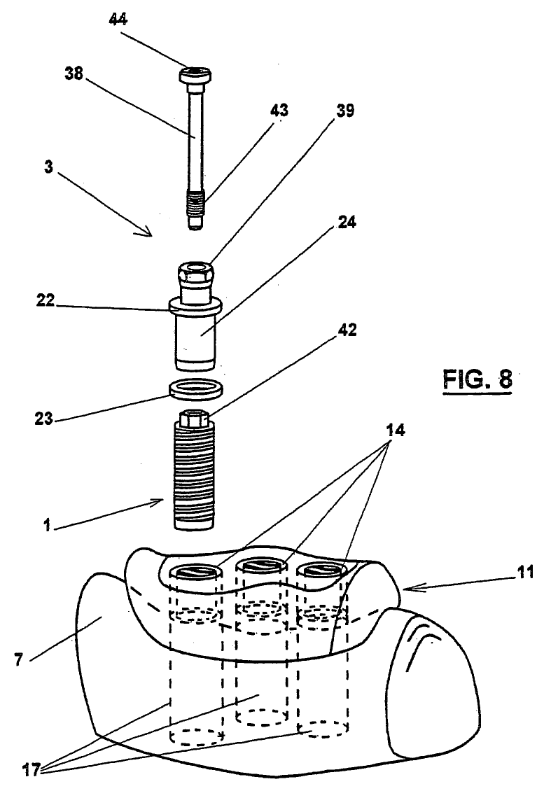

FIG. 8 represents an implant 1, a fixture mount 3 and the template 11 during the placement step 20 of the implants 1 following the drilling step 19 (the elements have been dissociated here for the clarity of the representation). The cavities 17 drilled in the boney tissue 7 in the exact location foreseen by the implant planning 10 will receive the implants 1. The guiding cylinders 14 of the template 11, from which the drilling tubes 18 have been unscrewed, allow the precise guiding of the implants 1 by way of the specific fixture mounts 3.

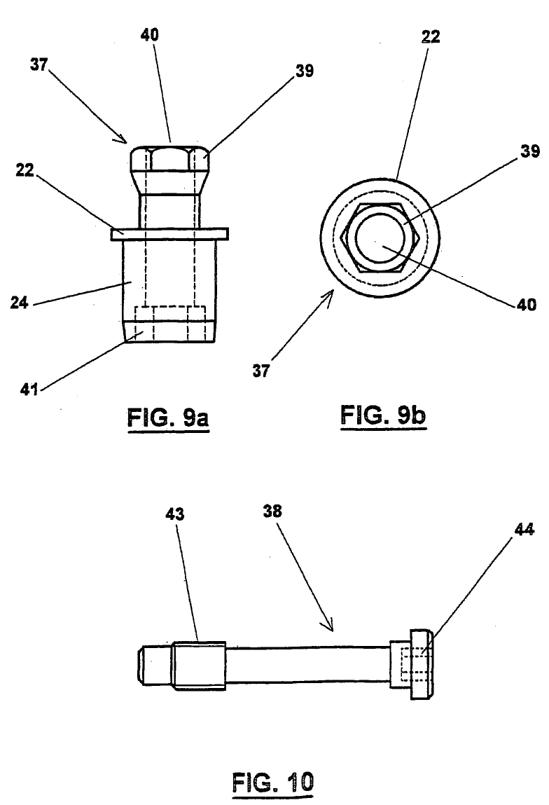

Each of these fixture mounts 3 according to the invention comprises on the one hand a composite shape which forms a mandrel 37 and on the other hand a fixing screw 38 of the implant 1. These two elements are represented respectively in FIGS. 9 and 10.

The mandrel 37 comprises an upper part 39 of a hexagonal section which forms a part which is complementary to an instrument-holder. This part 39 features an axial bore 40 and is linked to a smooth sleeve 24 by a flange 22 identical to that of the drills 4, 5. The base of the mandrel 37 comprises a cavity 41 which is hexagonal in cross-section complementary to the hexagonal head 42 of an implant 1, armed with a threaded blind hole. The screw 38 which passes through the mandrel 37 is screwed by way of its threaded end 43 into the hexagonal head 42 so as to inseparably fit together the implant 1 and the fixture mount 3. To achieve this, the head of the screw 38 of the fixture mount 3 is advantageously of a type having a hexagon socket 44.

The exterior diameter of the sleeve 24 of the mandrel 37 corresponds to the inside diameter of a guiding cylinder 14. In this way, the implant 1 is guided when placed into position by the gliding of sleeve 24 into the cylinder 14 of the template 11. The flange 22 going solid on the upper part of the cylinder 14 limits the insertion to the level desired by the surgeon. Thus, as has been set forth above, washers 23 in POM allow the precise control of this penetration depth.

The fixture mounts 3 can be divided into two main types based on their length: the osseous fixture mounts, which are short, and the long fixture mounts, adapted for transmucosal placement.

For the standard implants 1, the external diameter of the sleeve 24 of a fixture mount 3 is 4.15 mm, which ensures a soft gliding in a cylinder 14 having an inside diameter of 4.20 mm. The height of the sleeve 24 (height of the fixture mount under the flange) is 4.5 mm for the osseous fixture mounts, and 10.5 mm for the mucous fixture mounts. The total length of the screw 38 of the fixture mount 3 is respectively 13.5 mm and 19.5 mm. In the case of a “universal” osseous fixture mount and the “universal” mucous fixture mount, the sleeve 24 is respectively 10.0 mm and 15.0 mm high, and the screw 38 is respectively 19.0 mm and 24.0 mm long. The hexagon sockets 41 of the base of the mandrel 24 and the screw thread M2 43 of the screw 38 are compatible with most of the implants 1 on the market.

The washers 23 of the fixture mounts 3 are of the same plastic bio-compatible material as the rings 21 of the drills 4, 5.

In case of standard implants, their external diameter is the same as that of the flanges 22, and their inside diameter is 4.10 mm, which is slightly inferior to the external diameter of the sleeve 24. Their thickness is either 0.5 mm, or 1.5 mm. Preferably, the thinner ones are white and the thicker ones are black, so as to not to confuse one for the other.

The whole of the characteristics provides to the method and to the device for the placement of dental implants according to the invention several noteworthy advantages over the prior art:
only two drills are used (for every type of implant) instead of several drills of different lengths and different diameters,
the specific template allows drilling without calculations and adjustments to the appropriate depth,
one single model of drilling tubes is required (for every type of implant) instead of a series of tubes with increasing inside diameters,
the handling of the tubes is made easier as their specific mechanical design allows them to be engaged in the guiding cylinders by simple screwing over a quarter of a turn,
the security is increased by the tubes having a “parachute”, and
the fixture mounts are guided precisely during the placement of the implant.

The method and the device described above can in some cases be simplified so as not to make use of the rings 21 and/or the washers 23 to adapt the depth of penetration of the drills 4, 5 and, respectively, of the fixture mounts 3, independent of the depth of drilling, the thickness of the gums or how deep the implants are applied.

It is known that the drills most frequently used have lengths of 10, 13, 15, 18 and 20 mm.

Moreover, the lengths of the implants most frequently used are: 8,5; 10; 11,5; 13; 15; 18 and 20 mm.

Knowing that X equals the length of the of the drill that is used or it can be used, minus the length of the implant to be placed, X must allow the use of an available fixture mount, without rings or washers, by choosing X+4 as the length of the fixture mount.

Each time that this will be possible, the value of X will be chosen so that it can comply with the two prerequisites cited above while a drill of a specific length and a fixture mount of a similarly specific length are used.

Thus, this value X will be independent of the insertion depth of the implant into the bone and of its position with regard to the osseous crest, but also independent of the operating method used (osseous guide or mucous guide), independent of the value of the thickness of the gums and independent of the determination of the surface of the osseous crest.

In most cases, it will thus be possible to drill and then place an implant without having to use neither a ring 21 nor a washer 23, or by having to use a ring but no washer or a washer but no ring.

Lengths of the fixture mounts of 4, 5, 6, 7, 9, 10, 11, 12, 14 and 17 mm will in practice allow to respond to all hypothetical cases of the above-cited values, i.e. preventing the use of a ring and/or the use of a washer.

It is of course understood that the invention is not limited only to the preferred embodiments described above. To the contrary, it encompasses all possible variant embodiments that would be in accordance with the concept of the present invention as defined by the following claims.

1-34. (canceled)

35. Device for placing dental implants (1), of such a type comprising:
a) a template (11) having bore tubes (15) in predetermined positions and with predetermined inclinations, which are provided with guiding cylinders (14) with standard dimensions, determined in advance in function of the type of said implants (1), and
b) fixture mounts (3)
characterized in that said fixture mounts have a smooth section (24) with an outer diameter determined in advance in function of the type of said implants and corresponding to the inner diameter of the guiding cylinders.

36. Device for placing dental implants (1) according to claim 35, characterized in that each of the fixture mounts (3) consists of a mandrel (37), which in addition to a smooth section (24) features successively along its axis:
a piece (39) complementary to a handpiece-connector or insertion tool
a flange (22), and
a piece (41) complementary to the heads (42) of the said implants (1).

37. Device for placing dental implants (1) according to claim 36, characterized in that each fixture mount (3) additionally consists of a screw (38) that passes through said mandrel (37) and is screw into said heads of the implants (42).

38. Device for placing dental implants (1) according to any one of claims 35 to 37, characterized in that said bore tubes (15) have a variable length in order to provide control over the insertion depth of the implant.

39. Device for placing dental implants (1) according to claim 35, characterized in that said device further comprises a set of washers (23) with inner diameters corresponding to the diameter of the fixture mounts (3), said washers (23) intended to be slid over the smooth sections (24) of each of the said fixture mounts (3) in order to control the insertion depth of the implants.

40. Device for placing dental implants (1) according to claim 35, characterized in that said fixture mounts (3) all have the same length, predetermined in function of the type of said implants (1), independent of the length of said implants (1).

41. Drilling device for placing dental implants (1), of such a type comprising:
a) A template (11) having bore tubes (15) in predetermined positions and with predetermined inclinations, which are provided with guiding cylinders (14) with standard dimensions, determined in advance in function of the type of said implants (1),
b) Drilling tubes (18), which fit co-axially into the upper part (15) of said guiding cylinders (14), and
c) Drills (4,5) with diameters corresponding to the inner diameters of said drilling tubes (18) and characterized in that said drilling tubes (18) all have the same inner diameter that is determined in advance in function of the type of said implants (1) and in that said drills (4,5) feature a first set of staged drills (4) and a second set of calibration drills (5), which respective maximum diameters and nominal diameters correspond to the inner diameter of said drilling tubes (18).

42. Drilling device for placing dental implants (1) according to claim 41, characterized in that each of the staged drills (4) successively features along its axis—from the pointy extremity to the other—:
a first drill section (30) with a single diameter, determined in advance in function of the type of said implants (1),
a second drill section (31), adjacent to said first drill section (30), with a single diameter, determined in advance in function of the type of said implants (1) and larger than the diameter of said first drill section (30),
a smooth drill section (32) with a single diameter predetermined in function of the type of said implants (1) and corresponding to the inner diameter of said drilling tubes (18),
a flange (22), and
a standard shank (33) to connect with a hand piece.

43. Drilling device for placing dental implants (1) according to claim 41, characterized in that each of the calibration drills (5) successively features along its axis—from the pointy extremity to the other—:
a first cutting section (34) with a single diameter, determined in advance in function of the type of said implants (1), and corresponding to the inner diameter of said drilling tubes (18),
a second cutting section (35) with a diameter significantly smaller than the diameter of said first cutting section (34),
a smooth zone (36) with a single diameter predetermined in function of the type of said implants (1) and corresponding to the unique inner diameter of said drilling tubes (18),
a flange (22), and
a standard shank (33) to connect with a hand piece

44. Drilling device for placing dental implants (1) according to claim 41, characterized in that said drilling device further comprises a set of rings (21) with inner diameters corresponding to the diameter of the drills (4,5), said rings (21) intended to be slid over the smooth drill section (32) or smooth drill zone (36) of each drill (4,5) in order to control the depth of drilling.

45. Drilling device for placing dental implants (1) according to claim 41, characterized in that the staged drills (4) and the calibration drills (5) all have the same length, predetermined in function of the type of said implants (1), independent of the depth of the cavities that need to be realized.

46. Drilling device for placing dental implants (1) according to claim 41, characterized in that the guiding cylinders (14) and the drilling tubes (18), respectively have an inner thread (25) and an outer thread (26) encompassing four helices, each at 90° with respect to the next.

47. Device for placing dental implants according to claim 41, characterized in that the length of the bore tubes is variable in order to limit—without additional means—the penetration depth of the drills (4,5) into the mandible or the maxilla (7).

48. Device for placing dental implants (1) according to claim 35, comprising in addition, of said drilling device for placing dental implants according to claims 7.

49. Device according to claim 48, characterized in that the staged drills, the calibration drills and the fixture mounts each have a single standard length that is predetermined in function of the type of implants.
